(19) United States
(12) Patent Application Publication
(10) Pub. No.: US 2023/0010218 A1
(43) Pub. Date: Jan. 12, 2023

(54) HEATING DEVICE, FIXING DEVICE, AND IMAGE FORMING APPARATUS

(71) Applicants: Keitaro SHOJI, Kanagawa (JP); Takuya SESHITA, Kanagawa (JP); Yuusuke FURUICHI, Kanagawa (JP)

(72) Inventors: Keitaro SHOJI, Kanagawa (JP); Takuya SESHITA, Kanagawa (JP); Yuusuke FURUICHI, Kanagawa (JP)

(73) Assignee: Ricoh Company, Ltd., Tokyo (JP)

(21) Appl. No.: 17/847,589

(22) Filed: Jun. 23, 2022

(30) Foreign Application Priority Data
Jul. 9, 2021 (JP) 2021-114146

(51) Int. Cl. G03G 15/20

(52) U.S. Cl. CPC G03G 15/2053; G03G 15/2039; G03G 15/2064

(57) ABSTRACT

A heating device includes a first rotator, a second rotator, a heater, and a first, second and third temperature sensors. The second rotator contacts an outer circumferential surface of the first rotator to form a nip through which a recording medium passes. The heater heats the first rotator. The first temperature sensor is disposed outside a space extending from a first region through which a minimum recording medium passes and detects the temperature of the first rotator. The second temperature sensor is disposed outside the space extending from the first region and detects the temperature of the heater. The third temperature sensor is disposed outside the space extending from the first region and detects the temperature of the second rotator. At least one of the second temperature sensor or the third temperature sensor is disposed outside a space extending from a second region through which a maximum sheet passes.

### CROSS-REFERENCE TO RELATED APPLICATION

This patent application is based on and claims priority pursuant to 35 U.S.C. § 119(a) to Japanese Patent Application No. 2021-114146, filed on Jul. 9, 2021, in the Japan Patent Office, the entire disclosure of which is hereby incorporated by reference herein.

### BACKGROUND

### Technical Field

Embodiments of the present disclosure relate to a heating device and an image forming apparatus incorporating the heating device.

### Related Art

An image forming apparatus such as a copier and a printer includes a fixing device that is one type of heating device. In the fixing device, a sheet is nipped by a pair of rotators such as an endless belt and a roller and heated to fix an image onto the sheet.

Generally, the fixing device includes a temperature sensor such as a thermistor to control the temperature of a heater that heats the rotator of the pair of rotators to heat a sheet at an appropriate temperature.

### SUMMARY

This specification describes an improved heating device that includes a first rotator, a second rotator, a heater, a first temperature sensor, a second temperature sensor, and a third temperature sensor. The second rotator is in contact with an outer circumferential surface of the first rotator to form a nip, and a recording medium passes through the nip. The heater heats the first rotator. The first temperature sensor is disposed outside a space extending from a first region that allows a minimum recording medium to pass through. The first temperature sensor detects the temperature of the first rotator. The second temperature sensor is disposed outside the space extending from the first region and detects the temperature of the heater. The third temperature sensor is disposed outside the space extending from the first region and detects the temperature of the second rotator. At least one of the second temperature sensor or the third temperature sensor is disposed outside a space extending from a second region that allows a maximum recording medium to pass through.

This specification also describes an image forming apparatus including the heating device.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic sectional view of an image forming apparatus according to an embodiment of the present disclosure to illustrate a configuration of the image forming apparatus;

FIG. 2 is a schematic view of a fixing device incorporated in the image forming apparatus of FIG. 1;

FIG. 3 is a plan view of a heater according to the present embodiment;

FIG. 4 is an exploded perspective view of the heater of FIG. 3;

FIG. 5 is a perspective view of the connector connected to the heater of FIG. 3;

FIG. 6 is a schematic cross-sectional view of the fixing device according to a first embodiment of the present disclosure;

FIG. 7 is a schematic diagram illustrating a positional relationship between temperature sensors and sheet-passing regions;

FIG. 8 is a block diagram of a controller;

FIG. 9 is a schematic diagram illustrating a positional relationship between temperature sensors and a sheet-passing region of a sheet that is erroneously set and conveyed;

FIG. 10 is a schematic diagram illustrating a positional relationship between temperature sensors and a sheet-passing region of a sheet that is erroneously set and conveyed;

FIG. 11 is a top view of the heater to illustrate a heat generation range;

FIG. 12 is a top view of the heater to illustrate another example of the heat generation range;

FIG. 13 is a schematic diagram illustrating an arrangement of a heater temperature sensor and a pressure temperature sensor that are disposed at the same side with respect to a minimum sheet;

FIG. 14 is a schematic diagram illustrating a configuration of the fixing device according to a second embodiment of the present disclosure;

FIG. 15 is a schematic diagram illustrating a configuration of the fixing device according to a third embodiment of the present disclosure;

FIG. 16 is a schematic diagram illustrating a configuration of the fixing device according to a fourth embodiment of the present disclosure; and

FIG. 17 is a schematic cross-sectional view of the fixing device as a variation of the fixing device of FIG. 2.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise. Identical reference numerals are assigned to identical components or equivalents and a description of those components is simplified or omitted. Hereinafter, a fixing device incorporated in an image forming apparatus is described as a heating device according to an embodiment of the present disclosure.

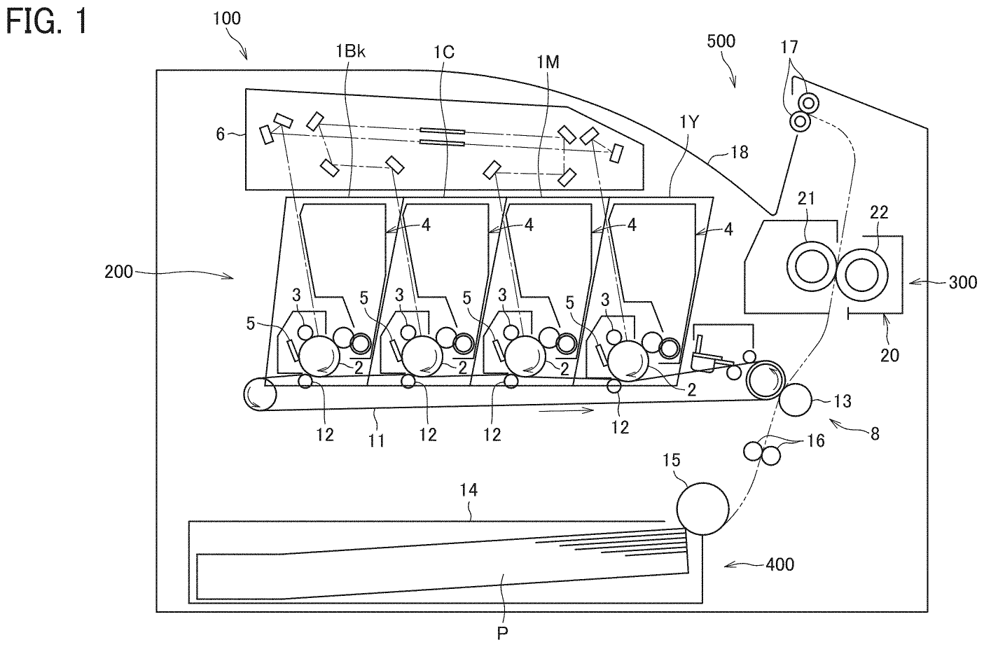

FIG. 1 is a schematic sectional view of an image forming apparatus according to an embodiment of the present disclosure to illustrate a configuration of the image forming apparatus. In the present disclosure, the image forming apparatus may be a copier, a facsimile machine, a printer, a plotter, multifunctional machines, or multifunction peripherals having a combination of the copying machine, the facsimile, the printer, and the plotter. The term “image formation” indicates an action for providing (i.e., printing) not only an image having a meaning, such as texts and figures on a recording medium, but also an image having no meaning, such as patterns on the recording medium. Initially, with reference to FIG. 1, a description is given of an overall configuration and operation of an image forming apparatus according to an embodiment of the present disclosure.

As illustrated in FIG. 1, an image forming apparatus 100 according to the present embodiment includes an image forming section 200 to form an image on a sheet-shaped recording medium such as a sheet, a fixing section 300 to fix the image onto the recording medium, a recording medium feeder 400 to feed the recording medium to the image forming section 200, and a recording medium ejection section 500 to eject the recording medium to an outside of the image forming apparatus 100.

The image forming section 200 includes four process units 1Y, 1M, 1C, and 1Bk as image forming units, an exposure device 6 that forms an electrostatic latent image on a photoconductor 2 in each of the process units 1Y, 1M, 1C, and 1Bk, and a transfer device 8 that transfers an image onto the recording medium.

The process units 1Y, 1M, 1C, and 1Bk have the same configuration except for containing different color toners (developers), i.e., yellow (Y), magenta (M), cyan (C), and black (Bk) toners, respectively, corresponding to decomposed color separation components of full-color images. Specifically, each of the process units 1Y, 1M, 1C, and 1Bk includes the photoconductor 2 serving as an image bearer bearing the image on the surface thereof, a charger 3 to charge the surface of the photoconductor 2, a developing device 4 to supply toner as a developer to the surface of the photoconductor 2 to form a toner image, and a cleaner 5 to clean the surface of the photoconductor 2.

The transfer device 8 includes an intermediate transfer belt 11, four primary transfer rollers 12, and a secondary transfer roller 13. The intermediate transfer belt 11 is an endless belt stretched by a plurality of support rollers. The four primary transfer rollers 12 are disposed inside a loop of the intermediate transfer belt 11. Each of the primary transfer rollers 12 is in contact with the corresponding photoconductor 2 via the intermediate transfer belt 11 to form a primary transfer nip between the intermediate transfer belt 11 and each photoconductor 2. The secondary transfer roller 13 is in contact with the outer circumferential surface off the intermediate transfer belt 11 to form a secondary transfer nip.

The fixing section 300 includes a fixing device 20. The fixing device 20 includes a fixing belt 21 as a fixing rotator and a pressure roller 22 as a pressure rotator. The pressure roller 22 is pressed against the fixing belt 21 to form a fixing nip between the fixing belt 21 and the pressure roller 22.

The recording medium feeder 400 includes a sheet tray 14 to store sheets P as recording media and a feed roller 15 to feed the sheet P from the sheet tray 14. The “recording medium” is described as a “sheet” in the following embodiments but is not limited to the sheet. Examples of the “recording medium” include not only the sheet of paper but also an overhead projector (OHP) transparency sheet, a fabric, a metallic sheet, a plastic film, and a prepreg sheet including carbon fibers previously impregnated with resin. Examples of the “sheet” include thick paper, a postcard, an envelope, thin paper, coated paper (e.g., coat paper and art paper), and tracing paper, in addition to plain paper.

The recording medium ejection section 500 includes an output roller pair 17 to eject the sheet to the outside of the image forming apparatus and an output tray 18 to place the sheet P ejected by the output roller pair 17.

Next, a printing operation of the image forming apparatus 100 according to the present embodiment is described with reference to FIG. 1.

When the image forming apparatus 100 starts the printing operation, the photoconductors 2 of the process units 1Y, 1M, 1C, and 1Bk and the intermediate transfer belt 11 of the transfer device 8 start rotating. The feed roller 15 starts to rotate and feeds the sheet P from the sheet tray 14. The sheet P fed from the sheet tray 14 is brought into contact with a timing roller pair 16 and temporarily stopped until the image forming section 200 forms the image to be transferred to the sheet P.

Firstly, in each of the process units 1Y, 1M, 1C, and 1Bk, the charger 3 uniformly charges the surface of the photoconductor 2 to a high potential. Next, the exposure device 6 exposes the surface (that is, the charged surface) of each photoconductor 2 based on image data of a document read by a document reading device or print image data sent from a terminal that sends a print instruction. As a result, the potential of the exposed portion on the surface of each photoconductor 2 decreases, and an electrostatic latent image is formed on the surface of each photoconductor 2. The developing device 4 supplies toner to the electrostatic latent image formed on the photoconductor 2, forming the toner image thereon. When the toner images formed on the photoconductors 2 reach the primary transfer nips defined by the primary transfer rollers 12 with the rotation of the photoconductors 2, the toner images formed on the photoconductors 2 are transferred onto the intermediate transfer belt 11 rotated counterclockwise in FIG. 1 successively such that the toner images are superimposed on the intermediate transfer belt 11, forming a full color toner image thereon. Thus, the full color toner image is formed on the intermediate transfer belt 11. The image forming apparatus 100 can form a monochrome toner image by using any one of the four process units 1Y, 1M, 1C, and 1Bk, or can form a bicolor toner image or a tricolor toner image by using two or three of the process units 1Y, 1M, 1C, and 1Bk. After the toner image is transferred from the photoconductor 2 onto the intermediate transfer belt 11, the cleaner 5 removes residual toner that are remained on the photoconductor 2 from the surface of the photoconductor 2.

In accordance with rotation of the intermediate transfer belt 11, the full color toner image transferred onto the intermediate transfer belt 11 reaches the secondary transfer nip at the secondary transfer roller 13 and is transferred onto the sheet P conveyed by the timing roller pair 16 at the secondary transfer nip. The sheet P bearing the full color toner image is conveyed to the fixing device 20. In the fixing device 20, the fixing belt 21 and the pressure roller 22 fix the full color toner image onto the sheet P under heat and pressure. Thereafter, the sheet P is conveyed to the recording medium ejection section 500 and ejected to the output tray 18 by the output roller pair 17. Thus, a series of image forming operations is completed.

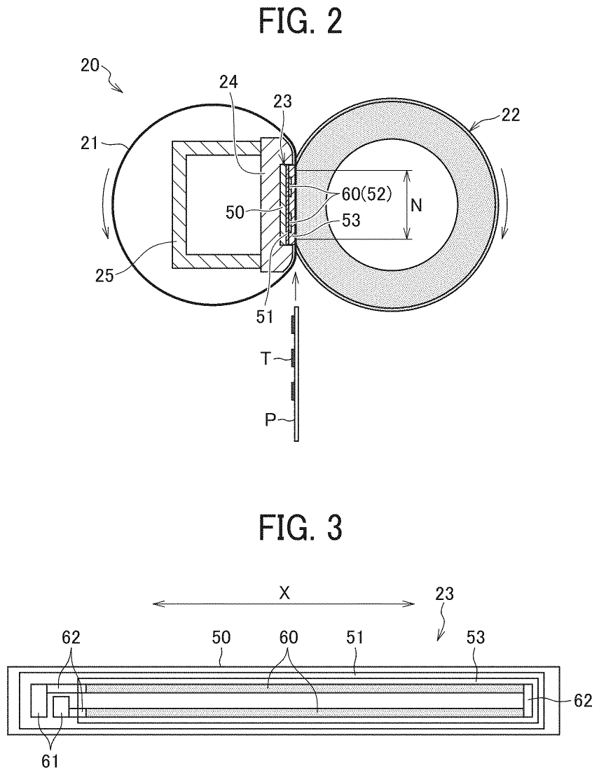

Next, with reference to FIG. 2, a description is given of the configuration of the fixing device 20 according to the present embodiment.

As illustrated in FIG. 2, the fixing device 20 includes a heater 23 as a heater, a heater holder 24 as a holder to hold the heater 23, and a stay 25 as a support in addition to the fixing belt 21 and the pressure roller 22.

The fixing belt 21 is a rotator (a first rotator) that functions as a fixing rotator to fix an unfixed toner image T (that is the full color toner image) onto the sheet P. A pair of belt holders is inserted into both ends of the loop of the fixing belt 21 and holds the inner circumferential surface of the fixing belt 21 by a free belt system that does not apply tension to the fixing belt 21 at least while the fixing belt 21 does not rotate. For example, the fixing belt 21 is an endless belt and includes a tubular base mainly made of polyimide (PI). The tubular base has an outer diameter of 25 mm and a thickness of 40 to 120 μm. The base of the fixing belt 21 may be made of heat-resistant resin such as polyetheretherketone (PEEK) or metal such as nickel (Ni) or stainless steel (Stainless Used Steel (SUS)), instead of polyimide. In the case that the base is made of metal, a sliding layer made of polyimide, polytetrafluoroethylene (PTFE), or the like may be on the inner circumferential surface of the base.

The fixing belt 21 further includes a release layer serving as an outermost surface layer. The release layer is made of fluororesin, such as tetrafluoroethylene-perfluoroalkylvinylether copolymer (PFA) or polytetrafluoroethylene (PTFE) and has a thickness of from 5 μm to 50 μm to enhance durability of the fixing belt 21 and facilitate separation of the sheet P from the fixing belt 21. Optionally, an elastic layer that is made of rubber or the like and has a thickness in a range of from 50 μm to 500 μm may be interposed between the base and the release layer.

The pressure roller 22 is a rotator as a second rotator disposed to face the fixing belt 21. The pressure roller 22 is also a pressure rotator that is pressed against the fixing belt 21 to form a nip N. The pressure roller 22 includes a cored bar made of metal such as iron, an elastic layer on the outer circumferential surface of the cored bar, and a release layer on the outer circumferential surface of the elastic layer. The elastic layer is, for example, made of silicone rubber and has a thickness of 3.5 mm. The release layer is, for example, made of fluororesin and has a thickness of approximately 40 μm.

A biasing member such as a spring presses the pressure roller 22 against the fixing belt 21 so that the pressure roller 22 is pressed against and in contact with the outer circumferential surface of the fixing belt 21. Thus, the nip N is formed between the fixing belt 21 and the pressure roller 22 (on a contact part on which the fixing belt 21 is in contact with the pressure roller 22).

The heater 23, the heater holder 24, and the stay 25 are disposed inside the loop of the fixing belt 21.

The heater 23 is a planar heater extending in a longitudinal direction of the fixing belt 21 (that is, a width direction of the sheet intersecting a sheet conveyance direction). The heater 23 is disposed so as to be in contact with the inner circumferential surface of the fixing belt 21. Therefore, as the heater 23 generates heat, the heat heats the inner circumferential surface of the fixing belt 21. An output of the heater 23 is controlled based on temperatures of the fixing belt 21 and the like that are detected by temperature sensors described below to keep the temperature of the fixing belt 21 within a predetermined temperature range including a predetermined fixing temperature that is a target temperature. While the temperature of the fixing belt 21 is controlled to be within the predetermined temperature range, the sheet P bearing the unfixed toner image enters the nip N between the fixing belt 21 and the pressure roller 22 as illustrated in FIG. 2. In the nip N, the fixing belt 21 and the pressure roller 22 press and heat the unfixed toner image to fix the unfixed toner image onto the sheet P.

The heater holder 24 holds the heater 23. Since the heater holder 24 is subject to temperature increase by heat from the heater 23, the heater holder 24 is preferably made of a heat-resistant material. In the case that the heater holder 24 is made of a heat-resistant resin having low heat conductivity, such as a liquid crystal polymer (LCP) or polyether ether ketone (PEEK), the heater holder 24 has a heat-resistant property and reduces heat transfer from the heater 23 to the heater holder 24. As a result, the heater 23 can efficiently heats the fixing belt 21.

The stay 25 supports the heater holder 24. The stay 25 supports a stay side face of the heater holder 24. The stay side face is opposite a nip side face of the heater holder 24. Accordingly, the stay 25 prevents the heater holder 24 from being bended by a pressing force of the pressure roller 22. Thus, the fixing nip N is formed between the fixing belt 21 and the pressure roller 22 to be a uniform width. The stay 25 is preferably made of an iron-based metal such as steel use stainless (SUS) or steel electrolytic cold commercial (SECC) that is electrogalvanized sheet steel to ensure rigidity.

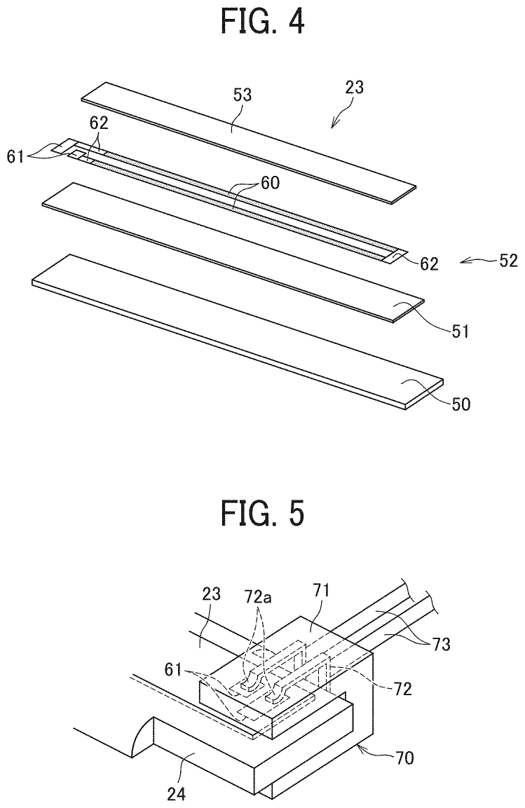

FIG. 3 is a plan view of the heater 23 according to the present embodiment, and FIG. 4 is an exploded perspective view of the heater 23.

As illustrated in FIGS. 3 and 4, the heater 23 includes a substrate 50 that is a plate extending in a direction indicated by arrow X in FIG. 3, that is, the longitudinal direction of the fixing belt 21 and the direction of the rotation axis of the pressure roller 22. A first insulation layer 51, a conductor layer 52, and a second insulation layer 53 are layered on the substrate 50.

The substrate 50 is made of a metal material such as stainless steel (SUS), iron, or aluminum. The substrate 50 may be made of ceramic, glass, etc. instead of the metal material. The substrate 50 made of an insulating material such as ceramic allows omitting the first insulation layer 51 sandwiched between the substrate 50 and the conductor layer 52. In contrast, since the metal material is processed readily and has an excellent durability when it is rapidly heated, the metal material is preferably used to reduce manufacturing costs. Among the metal materials, aluminum and copper are preferable because aluminum and copper have high thermal conductivity and are less likely to cause uneven temperature. Stainless steel is advantageous because the substrate 50 made of stainless steel is manufactured at reduced costs compared to aluminum and copper.

The conductor layer 52 includes resistive heat generators 60, electrodes 61, and power supply lines 62 (that is, conductive portions). The resistive heat generators 60 extend in the longitudinal direction of the substrate 50 that is the direction indicated by arrow X in FIG. 3 and are arranged in two rows in a direction intersecting the longitudinal direction. Each of the resistive heat generators 60 is electrically coupled to the two electrodes 61 disposed on one end of the substrate 50 in the longitudinal direction (that is the left end of the substrate 50 in FIG. 3) via the power supply lines 62. Specifically, as illustrated in FIG. 3, one ends of two rows of resistive heat generators 60 (that are left ends in FIG. 3) are electrically coupled to the two electrodes 61 via the power supply lines 62, respectively, and the other ends of the resistive heat generators 60 are electrically coupled each other via another power supply line 62.

For example, the resistive heat generators 60 are produced as below. Silver-palladium (AgPd), glass powder, and the like are mixed to make paste. The paste is screen-printed on the first insulation layer 51 layered on the substrate 50. Thereafter, the substrate 50 is subject to firing. Then, the resistive heat generators 60 are produced. The material of the resistive heat generator 60 may contain a resistance material, such as silver alloy (AgPt) or ruthenium oxide (RuO₂), other than the above material.

The electrodes 61 and the power supply lines 62 are made of conductors having an electrical resistance value smaller than the electrical resistance value of the resistive heat generators 60. Specifically, the electrodes 61 and the power supply lines 62 may be made of a material prepared with silver (Ag), silver-palladium (AgPd), or the like. Screen-printing such a material on the first insulation layer 51 disposed on the substrate 50 forms the electrodes 61 and the power supply lines 62.

The second insulation layer 53 covers the entire resistive heat generators 60 and at least a part of the power supply lines 62 to ensure the insulation of the surface of the heater 23. In contrast, the second insulation layer 53 does not cover the electrodes 61 to expose the electrodes 61 so as to be connected to a connector described below.

The first insulation layer 51 and the second insulation layer 53 are made of material having electrical insulation, such as heat-resistant glass. Alternatively, each of the first insulation layer 51 and the second insulation layer 53 may be made of ceramic, polyimide, or the like. In addition, another insulation layer as a third insulation layer may be disposed on one surface of the substrate 50 opposite to the other surface on which the first insulation layer 51 and the second insulation layer 53 are disposed.

In the present embodiment, since the resistive heat generators 60 are disposed above a side of the substrate 50 facing the nip N (see FIG. 2), the heat of the resistive heat generators 60 is transmitted to the fixing belt 21 without passing through the substrate 50 and can efficiently heat the fixing belt 21. Alternatively, the resistive heat generators 60 may be disposed above a side of the substrate 50 opposite the side of the substrate 50 facing the nip N. In this case, since the heat of the resistive heat generators 60 is transmitted to the fixing belt 21 through the substrate 50, it is preferable that the substrate 50 be made of a material with high thermal conductivity such as aluminum nitride.

FIG. 5 is a perspective view of a connector 70 as a power supply member connected to the heater 23.

As illustrated in FIG. 5, the connector 70 includes a housing 71 made of resin and a plurality of contact terminals 72. Each contact terminal 72 is an elastic member having conductivity such as a flat spring. The contact terminals 72 are disposed on the housing 71. The contact terminals 72 are coupled to harnesses 73 that supply power, respectively.

The connector 70 is attached to the heater 23 and the heater holder 24 such that the connector 70 sandwiches the heater 23 and the heater holder 24 together. Thus, the connector 70 holds the heater 23 and the heater holder 24. In the connector 70 attached to the heater 23, contact portions 72a disposed at ends of the contact terminals 72 elastically contact and press against the electrodes 61 each corresponding to the contact terminals 72 to electrically connect the electrodes 61 and the contact terminals 72, respectively. As a result, a power supply disposed in the image forming apparatus body can supply power to the resistive heat generators 60. Supplying the power from the power supply to the resistive heat generators 60 via the connector 70 causes heat generation in the resistive heat generators 60.

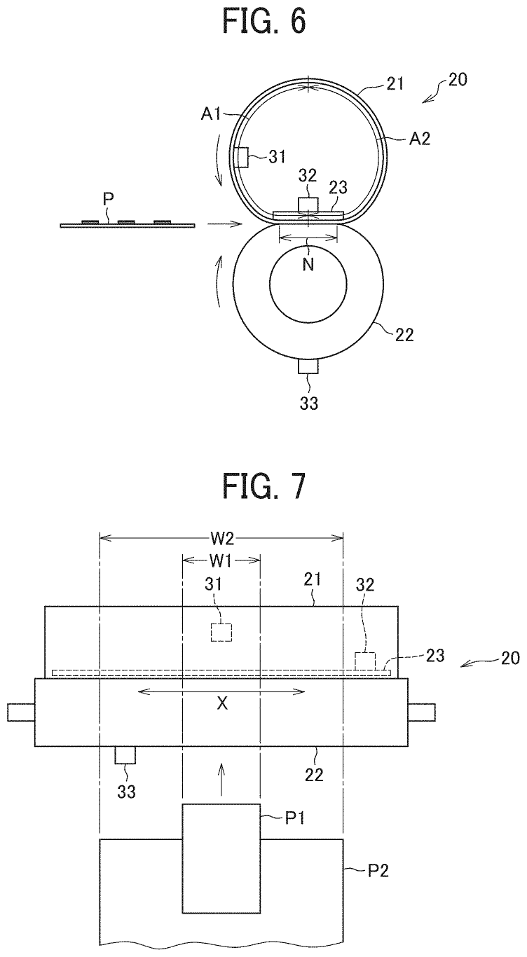

As illustrated in FIG. 6, the fixing device 20 in the present embodiment includes three temperature sensors 31, 32, and 33. Specifically, the three temperature sensors 31, 32, and 33 are a fixing temperature sensor 31 serving as a first temperature sensor to detect the temperature of the fixing belt 21, a heater temperature sensor 32 serving as a second temperature sensor to detect the temperature of the heater 23, and a pressure temperature sensor 33 serving as a third temperature sensor to detect the temperature of the pressure roller 22. Each of the temperature sensors 31, 32, and 33 may be a known temperature sensor such as a thermopile, a thermostat, a thermistor, or a non-contact (NC) sensor. Note that the lateral direction in FIG. 6 corresponds to the vertical direction in FIG. 2.

The fixing temperature sensor 31 is disposed inside the loop of the fixing belt 21. The fixing temperature sensor 31 in the present embodiment is a contact type temperature detector that is in contact with the inner circumferential surface of the fixing belt 21 to detect the temperature of the fixing belt 21. Instead of the contact type temperature sensor, the non-contact type temperature sensor may be used. The non-contact type temperature sensor as the fixing temperature sensor 31 detects temperature in a space around the fixing belt 21 as the temperature of the fixing belt 21. The fixing temperature sensor 31 may be disposed outside the fixing belt 21. The fixing temperature sensor disposed outside the fixing belt 21 may be in contact with the outer circumferential surface of the fixing belt 21, but the fixing temperature sensor facing the outer circumferential surface of the fixing belt 21 not to be in contact with the outer circumferential surface of the fixing belt 21 does not cause abrasion of the fixing belt 21 due to the fixing temperature sensor 31 in contact with the fixing belt 21 and, therefore, can avoid a negative impact to a fixing property. The fixing temperature sensors 31 disposed inside the loop of the fixing belt 21 is more preferable because disposing the fixing temperature sensor 31 inside the loop of the fixing belt 21 enables downsizing the fixing device 20 in addition to avoiding the abrasion of the outer circumferential surface of the fixing belt 21.

The heater temperature sensor 32 is disposed so as to be in contact with a surface of the heater 23 opposite a surface of the heater 23 facing the nip N. The heater temperature sensor 32 may be a non-contact type temperature sensor that detects temperature in a space around the heater 23.

The pressure temperature sensor 33 is disposed so as to be in contact with an outer circumferential surface of the pressure roller 22. Similar to the above-described temperature sensors, the pressure temperature sensor 33 may be a non-contact type temperature sensor that detects temperature in a space around the pressure roller 22.

FIG. 7 is a schematic diagram illustrating a positional relationship between the temperature sensors 31, 32, and 33 and sheet-passing regions according to a first embodiment.

As illustrated in FIG. 7, the fixing temperature sensor 31 according to the first embodiment is disposed at a position in a space extending from a minimum sheet-passing region (that is, a minimum recording medium passing region that is also referred to as a first region) W1 through which the sheet P1 having the smallest width among widths of the sheets used in the image forming apparatus passes. The pressure temperature sensor 33 according to the first embodiment is disposed at a position in a space outside the space extending from the minimum sheet-passing region W1, and the position is in a space extending from a maximum sheet-passing region (that is, a maximum recording medium region that is also referred to as a second region) W2 through which the sheet P2 having the largest width among widths of the sheets used in the image forming apparatus passes. The heater temperature sensor 32 according to the first embodiment is disposed at a position in a space outside the space extending from the maximum sheet-passing region W2.

In the above description, “a space extending from a sheet-passing region” means a space extending in a direction orthogonal to the width direction (the direction indicated by arrow X in FIG. 7) from the sheet-passing region. In addition, “a space outside the space extending from the sheet-passing region” means a space outside the space extending in a direction orthogonal to the width direction from the sheet-passing region. The width direction means the width direction of the sheet-passing region that is a direction orthogonal to the sheet conveyance direction, a direction intersecting the sheet conveyance direction, the longitudinal direction of fixing belt 21, or the direction of the rotation axis of the pressure roller 22. The temperature sensor disposed in the space extending from the sheet-passing region means that a half or more of the temperature detecting portion (that is, the temperature detecting element) of the temperature sensor is in the space extending from the sheet-passing region, and the temperature sensor disposed in the space outside the space extending from the sheet-passing region means that the half or more of the temperature detecting portion (that is, the temperature detecting element) of the temperature sensor is in the space outside the space extending from the sheet-passing region.

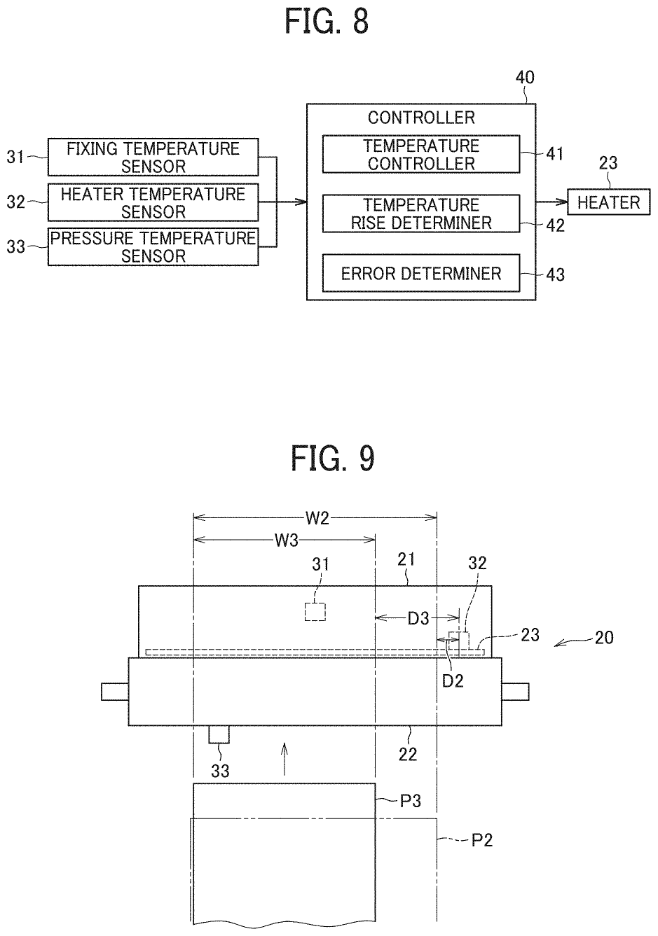

FIG. 8 is a block diagram of a controller 40 controlling the heater 23.

As illustrated in FIG. 8, the controller 40 according to the present embodiment controls the heater 23 based on temperatures detected by the three temperature sensors 31, 32, and 33. The controller 40 is circuitry such as a microcomputer including a read only memory (ROM) and a random-access memory (RAM). The controller 40 may be disposed in the image forming apparatus body or the fixing device.

Specifically, the controller 40 includes a temperature controller 41, a temperature rise determiner 42 to determine whether a temperature rise occurs in a non-sheet-passing region, and an error determiner 43 to determine whether the sheet is wrongly set.

The temperature controller 41 controls an amount of heat generated by the heater 23 mainly based on a temperature detected by the fixing temperature sensor 31 to maintain the temperature of the fixing belt 21 to be the target temperature. Controlling the amount of heat generated by the heater 23 based on the temperature of the fixing belt 21 enables easily maintaining the temperature of the fixing belt 21 that largely affects the fixing property of the toner image to be the predetermined fixing temperature and improves image qualities. The position of the fixing temperature sensor 31 with respect to the fixing belt 21 may not necessarily be the position illustrated in FIG. 6. However, in the case that the region of the fixing belt 21 in the rotational direction is divided into an upstream region A1 and a downstream region A2 with reference to the center of the nip N (see FIG. 6), the fixing temperature sensor 31 is preferably disposed in the upstream region A1 in the rotational direction with respect to the center of the nip N.

The temperature controller 41 also controls the amount of heat generated by the heater 23 based on the temperature detected by the pressure temperature sensor 33 in addition to the temperature detected by the fixing temperature sensor 31. This is because an optimum fixing temperature of the fixing belt 21 varies depending on a heat storage state of the pressure roller 22 even when the same image is printed. In the first embodiment, the pressure temperature sensor 33 detects the temperature of the pressure roller 22 at a position of the pressure roller 22, the position outside the space extending from the minimum sheet-passing region W1 and inside the space extending from the maximum sheet-passing region W2. When the pressure temperature sensor 33 detects the temperature of the pressure roller 22 lower than a predetermined temperature, the temperature controller 41 sets a high target temperature to control the temperature of the fixing belt 21. In contrast, when the pressure temperature sensor 33 detects the temperature of the pressure roller 22 higher than the predetermined temperature, the temperature controller 41 sets a low target temperature to control the temperature of the fixing belt 21. Even if the heat storage state of the pressure roller 22 changes, the above-described control can apply a constant amount of heat to the sheet and stably supply excellent image quality. In addition, the above-described control can prevent unnecessary heat generation of the heater 23 and reduce energy consumption.

The temperature rise determiner 42 determines whether the temperature of the pressure roller 22 or the heater 23 excessively rises in a portion facing a non-sheet-passing region (in other words, a non-recording-medium-passing region) through which the sheet does not pass. In response to an occurrence of an excessive temperature rise, the temperature rise determiner 42 reduces the amount of heat generated by the heater 23 or stops the heat generation by the heater 23. For example, when multiple sheets P2 each having the largest width and being illustrated in FIG. 7 continuously pass through the fixing device, temperatures rise in portions facing the non-sheet-passing region because the sheets P2 do not absorb heat from the portions. As a result, the heater temperature sensor 32 disposed outside the space extending from the maximum sheet-passing region W2 detects rising of the temperature of the heater 23. When the temperature detected by the heater temperature sensor 32 exceeds a predetermined temperature as an upper limit value, the temperature rise determiner 42 reduces the amount of heat generated by the heater 23 or stops the heat generation by the heater 23 based on the temperature detected by the heater temperature sensor 32. In addition, the temperature rise determiner 42 may reduce the number of printed sheets per minute (that is Copies Per Minute (CPM)) by lengthening the intervals between printing operations each printing the toner image on the sheet or decreasing a sheet conveyance speed to reduce the temperature rises in the portions facing the non-sheet-passing region.

In the case in which sheets each having a width smaller than the largest width pass through the fixing device in addition to the above-described case in which multiple sheets P2 each having the largest width continuously pass through the fixing device, the temperature rise determiner 42 may similarly determine whether the temperature excessively rises in the portion facing the non-sheet-passing region based on the temperature detected by the heater temperature sensor 32. Depending on the width of the sheet passing through the fixing device, the position at which the pressure temperature sensor 33 is disposed may face the non-sheet-passing region. In this case, the temperature rise determiner 42 may determine whether the temperature excessively rises in the portion facing the non-sheet-passing region based on the temperature detected by the pressure temperature sensor 33.

The error determiner 43 determines whether the size or the position of the sheet set in the sheet tray is wrong based on at least one of the temperature detected by the heater temperature sensor 32 and the temperature detected by the pressure temperature sensor 33.

For example, a case in which sheets P3 each having a width smaller than the largest width are accidentally set in the sheet tray in which the sheets P2 each having the largest width are originally set and the sheets P3 are conveyed as illustrated in FIG. 9 changes a positional relationship of the temperature sensor with respect to the sheet-passing region from an original positional relationship of the temperature sensor with respect to the sheet-passing region in a case in which the sheet P2 each having the largest width are correctly set and conveyed. In the example illustrated in FIG. 9, a distance D3 between the heater temperature sensor 32 and the sheet-passing region W3 through which the sheet P3 having the smaller width passes is larger than a distance D2 between the heater temperature sensor 32 and the sheet-passing region W2 through which the sheet P2 having the largest width passes. Since the above described increase in the distance between the heater temperature sensor 32 and the sheet-passing region reduces the consumption of heat due to the passing of sheets at the position of the heater temperature sensor 32, the temperature detected by the heater temperature sensor 32 tends to be higher than usual. Accordingly, the error determiner 43 can determine whether the sheet is wrongly set in the sheet tray based on the temperature detected by the heater temperature sensor 32.

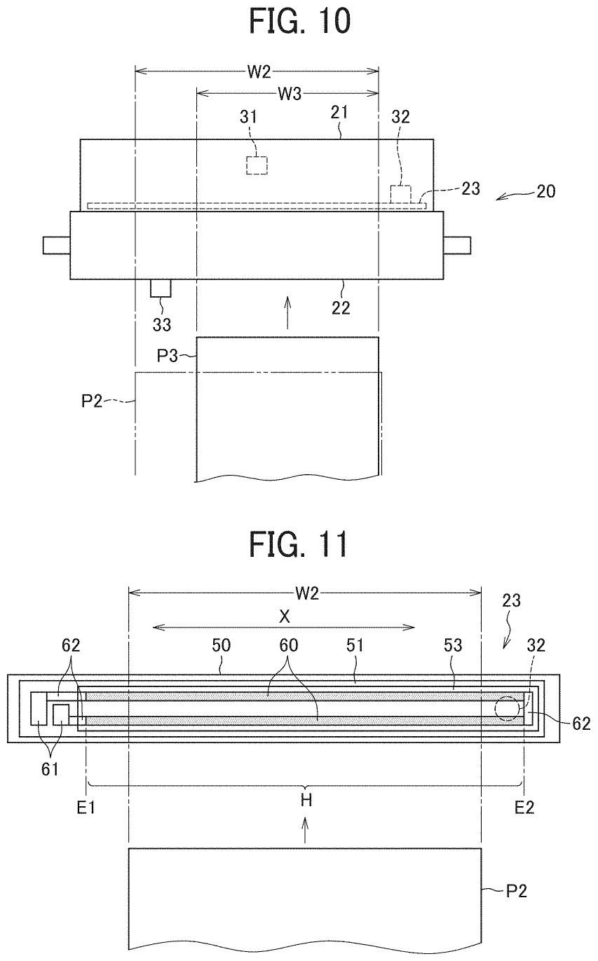

Additionally, as illustrated in FIG. 10, when the sheet P3 having the width smaller than the largest width passes through a right portion of the sheet conveyance span of the sheet P2 having the largest width from the center of the sheet P2 in the width direction, the pressure temperature sensor 33 disposed so as to face the left portion of the sheet P2 from the center of the sheet P2 in the width direction faces the non-sheet-passing region through which the sheet P3 does not pass. Originally, the pressure temperature sensor 33 faces the sheet-passing region through which the sheet P2 having the largest width passes. As a result, the temperature detected by the pressure temperature sensor 33 tends to be higher than usual. Accordingly, the error determiner 43 can determine whether the sheet is wrongly set in the sheet tray based on the temperature detected by the pressure temperature sensor 33.

When the error determiner 43 determines that the sheet is wrongly set based on the temperature detected by the heater temperature sensor 32 or the temperature detected by the pressure temperature sensor 33, the error determiner 43 may control a screen in the image forming apparatus to display a message or a speaker in the image forming apparatus to make sound and notify a user that the sheet is wrongly set. Alternatively, the error determiner 43 may stop operations including a sheet feeding operation in the image forming apparatus. In addition, the error determiner 43 may reduce the number of printed sheets per unit time or stop supplying power to the heater 23 when the temperature in the portion facing the non-sheet-passing region excessively increases as a result of the determination of the error determiner 43 that the sheet is wrongly set.

The examples illustrated in FIGS. 9 and 10 each describe the case in which the sheet having the width smaller than the largest width is wrongly set, but conversely, the error determiner 43 can determine whether a large sheet is wrongly set in the sheet tray to set the sheet having a smaller width than the set large sheet in the same manner. That is, accidentally setting the sheet having different size in the sheet tray causes the temperature detected by at least one of the temperature sensors to be different from the temperature usually detected by the at least one of the temperature sensors because the relative position of the at least one of the temperature sensors with respect to the sheet-passing region is different from the original position. Accordingly, the error determiner 43 can determine whether the sheet is wrongly set in the sheet tray based on the temperature detected by the at least one of the temperatures. The error determiner 43 can determine not only whether the size of sheet set in the sheet tray is wrong but also whether the sheet is conveyed to a position different from a normal position in the width direction as a result of setting the sheet to a wrong position by the same manner. In other words, the error determiner 43 can determine whether a setting error (set position shift) occurs in the same manner.

As described above, the fixing device 20 in the present embodiment includes the fixing temperature sensor 31 that is one of a plurality of temperature sensors. The fixing temperature sensor 31 can accurately detect the temperature of the fixing belt 21. Controlling the amount of heat generated by the heater 23 based on the detected temperature of the fixing belt 21 enables adequately maintaining the temperature of the fixing belt 21 to be the predetermined target temperature (that is, the predetermined fixing temperature). That is, the temperature controller 41 in the present embodiment does not indirectly control the temperature of the fixing belt 21 based on a temperature of a part other than the fixing belt 21 such as the heater 23. The temperature controller 41 in the present embodiment directly controls the temperature of the fixing belt 21 based on the temperature of the fixing belt 21, improving the temperature control accuracy of the fixing belt 21. Since the temperature rise in the portion facing the non-sheet-passing region does not affect the fixing temperature sensors 31 disposed inside the space extending from the minimum sheet-passing region W1 as illustrated in FIG. 7, the fixing temperature sensor 31 can accurately detect the temperature of the fixing belt 21 at the position on the fixing belt 21 in the space extending from the minimum sheet-passing region W1.

In addition, since the fixing device according to the present embodiment includes the pressure temperature sensor 33 that detects the temperature of the pressure roller 22, the temperature controller 41 can use data of the detected temperatures of the pressure roller 22 to control the temperature of the fixing belt 21. Since the above-described configuration enables supplying the amount of heat to the fixing belt 21 in accordance with the heat storage state of the pressure roller 22, the above-described configuration further improves the temperature control accuracy of the fixing belt 21 and also improves energy saving.

The fixing device according to the present embodiment includes the heater temperature sensor 32 that detects the temperature of the heater 23, and the heater temperature sensor 32 can detect the excessive temperature rise of the heater 23 due to a failure or the like with good responsiveness. The above-described configuration can instantaneously cut off the energization to the heater 23, thereby improving the safety. In addition, when the multiple sheets P2 having the largest width continuously pass through the fixing device and the temperature rise occurs in the portion facing the non-sheet-passing region, the heater temperature sensor 32 disposed outside the space extending from the maximum sheet-passing region W2 can detect the temperature rise in the portion of the heater 23 facing the non-sheet-passing region. Thus, when the heater temperature sensor 32 detects the temperature rise, the temperature controller 41 can reduce the amount of heat generated by the heater 23 to prevent the temperature rise and avoid damage to the fixing belt due to the excessive temperature rise, thereby improving reliability.

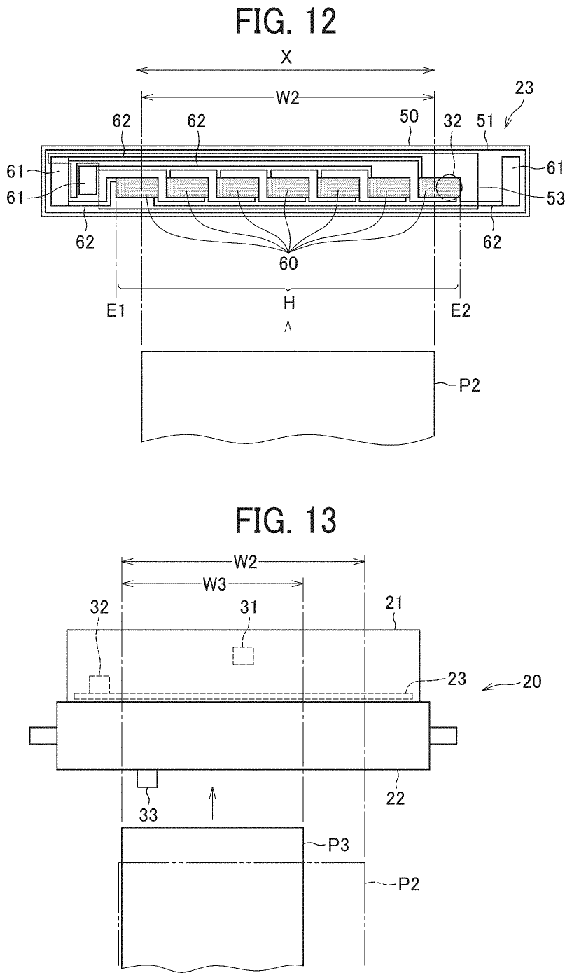

In a case in which the heater 23 includes the resistive heat generator overlapping the space outside the space extending from the maximum sheet-passing region W2, the temperature tends to be high particularly in a portion of the resistive heat generator, the portion facing the non-sheet-passing region. For example, in an example illustrated in FIG. 11, the resistive heat generators 60 disposed in a heat generation range H overlap the space outside the space extending from the maximum sheet-passing region W2. In this case, a temperature in the heat generation range H tends to increase in a portion facing the non-sheet-passing region that is the portion in the space outside the space extending from the maximum sheet-passing region W2. For this reason, it is preferable that the heater temperature sensor 32 faces the heat generation range H outside the space extending from the maximum sheet-passing region W2. In the example illustrated in FIG. 11, the heater 23 includes the resistive heat generators 60 extending in the longitudinal direction of the substrate 50 that is the direction indicated by arrow X. In FIG. 11, the “heat generation range” of the heater 23 means a range H from one ends E1 to the other ends E2 of the resistive heat generators 60 in the longitudinal direction. In an example illustrated in FIG. 12, a plurality of resistive heat generators 60 are arranged in the longitudinal direction of the substrate 50 that is the direction indicated by arrow X. In FIG. 12, the heat generation range H means a range from one end E1 to the other end E2. The one end E1 and other end E2 are both ends of the resistive heat generators 60 separated from each other. In the present specification, the heater temperature sensor 32 facing the heat generation range H means that half or more of the temperature detection portion (that is, the temperature detection element) of the heater temperature sensor 32 faces the heat generation range H.

Since the fixing device in the present embodiment is designed to have the minimum sheet-passing region W1 between the heater temperature sensor 32 and the pressure temperature sensor 33 as illustrated in FIG. 7, the error determiner 43 can determine whether the sheet is wrongly set based on at least one of the temperature detected by the heater temperature sensor 32 and the temperature detected by the pressure temperature sensor 33.

In contrast, in the fixing device including the heater temperature sensor 32 and the pressure temperature sensor 33 arranged on the same side in the width direction with respect to the minimum sheet-passing region W1 as illustrated in FIG. 13, which is different from the above-described embodiment, the error determiner 43 may not determine whether the sheet is wrongly set even if the sheet is wrongly set. For example, in FIG. 13, the sheet P3 having the width smaller than the largest width is accidentally set in the sheet tray in which the sheet P2 having the largest width is originally set, and the sheet P3 passes through the fixing device 20 as illustrated in FIG. 13. In this case, the positional relationship between the heater temperature sensor 32 and the pressure temperature sensor 33 with respect to the left side of the sheet-passing region W3 is the same as the positional relationship between the heater temperature sensor 32 and the pressure temperature sensor 33 with respect to the left side of the sheet P1 having the largest width. Accordingly, since the temperature detected by the heater temperature sensor 32 and the temperature detected by the pressure temperature sensor 33 are substantially the same as the normally detected temperatures, the error determiner cannot determine whether the sheet is wrongly set based on the temperature detected by the heater temperature sensor 32 and the temperature detected by the pressure temperature sensor 33. In contrast, the fixing device 20 in the present embodiment includes the heater temperature sensor 32 disposed on one side in the width direction with respect to the minimum sheet-passing region and the pressure temperature sensor 33 disposed on the other side in the width direction with respect to the minimum sheet-passing region. As described above, since wrongly setting the sheet changes the positional relationship of at least one of the temperature sensors with respect to the sheet-passing region, the error determiner 43 can determine whether the sheet is wrongly set.

However, the heating device such as the fixing device 20 in the embodiments of the present disclosure may be configured as illustrated in FIG. 13. In the case in which the error determiner 43 is not required, the heater temperature sensor 32 and the pressure temperature sensor 33 may be disposed on the same side in the width direction with respect to the minimum sheet-passing region. Even in such a case, the temperature control accuracy, the safety, and the reliability are improved as described above by the fixing temperature sensors 31 disposed inside the space extending from the minimum sheet-passing region W1, the pressure temperature sensor 33 disposed in the space outside the space extending from the minimum sheet-passing region W1 and in the space extending from the maximum sheet-passing region W2, and the heater temperature sensor 32 disposed outside the space extending from the maximum sheet-passing region W2.

Next, a second embodiment of the present disclosure is described with reference to FIG. 14.

In the second embodiment illustrated in FIG. 14, an arrangement of the heater temperature sensor 32 and the pressure temperature sensor 33 is different from the arrangement in the above-described embodiment as illustrated in FIG. 7. Specifically, the heater temperature sensor 32 according to the second embodiment is disposed outside the space extending from the minimum sheet-passing region W1 and inside the space extending from the maximum sheet-passing region W2, and the pressure temperature sensor 33 according to the second embodiment is disposed outside the space extending from the maximum sheet-passing region W2. That is, the positional relationship of the heater temperature sensor 32 with respect to the sheet-passing regions and the positional relationship of the pressure temperature sensor 33 with respect to the sheet-passing region in the second embodiment are opposite to those in the above-described first embodiment. As in the first embodiment, the fixing temperature sensor 31 is disposed inside the space extending from the minimum sheet-passing region W1.

The heating device such as the fixing device having the positional relationship of the heater temperature sensor 32 and the pressure temperature sensor 33 in the second embodiment that is opposite to the positional relationship in the first embodiment as described above can improve the temperature control accuracy, the safety, and the reliability, which is similar to the first embodiment.

That is, similar to the above-described embodiment, the fixing temperature sensor 31 detects the temperature of the fixing belt 21, and the pressure temperature sensor 33 detects the temperature of the pressure roller 22. Since the temperature controller 41 checks the heat storage state of the pressure roller 22 based on the temperature of the pressure roller 22, the above-described configuration can improve the temperature control accuracy and the energy saving.

The pressure temperature sensor 33 disposed outside the space extending from the maximum sheet-passing region W2 can detect the temperature rise in the portion facing the non-sheet-passing region that occurs when a plurality of sheets P2 having the largest width continuously pass through the fixing device 20. Accordingly, the above-described configuration can detect the temperature rise and prevent the damage to the fixing belt 21 due to the temperature rise, thereby improving the reliability. The temperature of the pressure roller 22 is relatively lower than the temperature of the heater 23 and the temperature of the fixing belt 21. Using the pressure temperature sensor 33 as the temperature sensor to detect the portion facing the non-sheet-passing region in the second embodiment enables using a low heat-resistant temperature sensor, thereby reducing a manufacturing cost.

Similar to the above-described embodiment, the heater temperature sensor 32 in the second embodiment can detect the temperature rise in the heater 23 with good responsiveness. Therefore, the configuration in the second embodiment quickly takes measures after the temperature of the heater 23 rises due to an abnormality and improves the safety.

Since the fixing device in the second embodiment is designed to have the minimum sheet-passing region W1 between the heater temperature sensor 32 and the pressure temperature sensor 33 as illustrated in FIG. 14, the error determiner 43 can determine whether the sheet is wrongly set based on at least one of the temperature detected by the heater temperature sensor 32 and the temperature detected by the pressure temperature sensor 33.

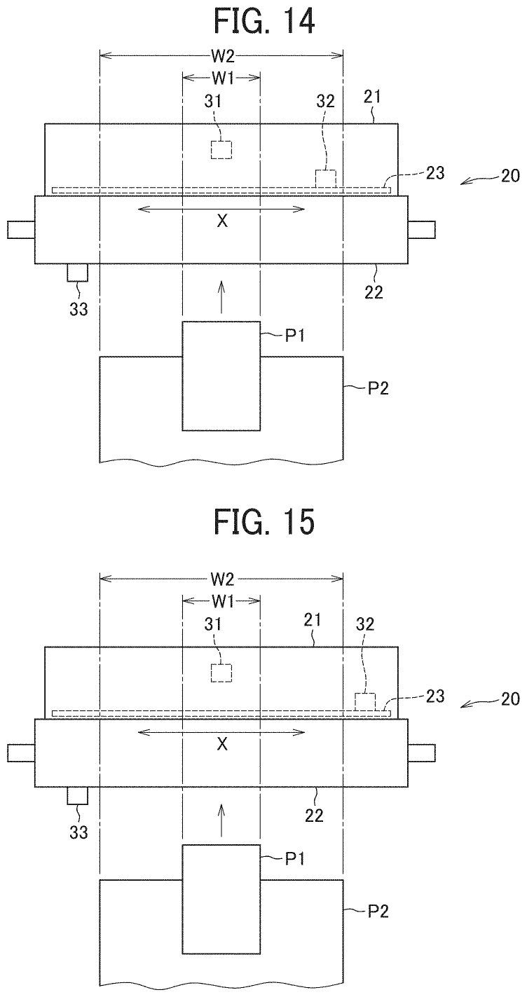

With reference to FIG. 15, a third embodiment of present disclosure is described.

The third embodiment illustrated in FIG. 15 is different from the above-described embodiments in that both the heater temperature sensor 32 and the pressure temperature sensor 33 are disposed outside the space extending from the maximum sheet-passing region W2. Other than that, the configuration illustrated in the third embodiment is the same as that in each of the first embodiment and the second embodiment.

As descried above, both the heater temperature sensor 32 and the pressure temperature sensor 33 may be disposed outside the space extending from the maximum sheet-passing region W2. Basically, the configuration in the third embodiment similarly operates and gives the same effect as that of each of the first and second embodiments. Controlling the amount of heat generated by the heater 23 based on the temperature detected by the fixing temperature sensor 31 and the temperature detected by the pressure temperature sensor 33 improves the temperature control accuracy for controlling temperature of the fixing belt 21. In addition, since the heater temperature sensor 32 can detect abnormal heat generation of the heater 23, the safety is improved. Since the heater temperature sensor 32 and the pressure temperature sensor 33 are disposed outside the space extending from the maximum sheet-passing region W2, the temperature rise determiner 42 can determine the occurrence of the temperature rise in the portion facing the non-sheet-passing region caused by the sheets P2 having the largest width and continuously passing through the fixing device 20 based on at least one of the temperature detected by the heater temperature sensor 32 and the temperature detected by the pressure temperature sensor 33. Since the fixing device in the third embodiment is designed to have the minimum sheet-passing region W1 between the heater temperature sensor 32 and the pressure temperature sensor 33 as illustrated in FIG. 15, the error determiner 43 can determine whether the sheet is wrongly set based on at least one of the temperature detected by the heater temperature sensor 32 and the temperature detected by the pressure temperature sensor 33.

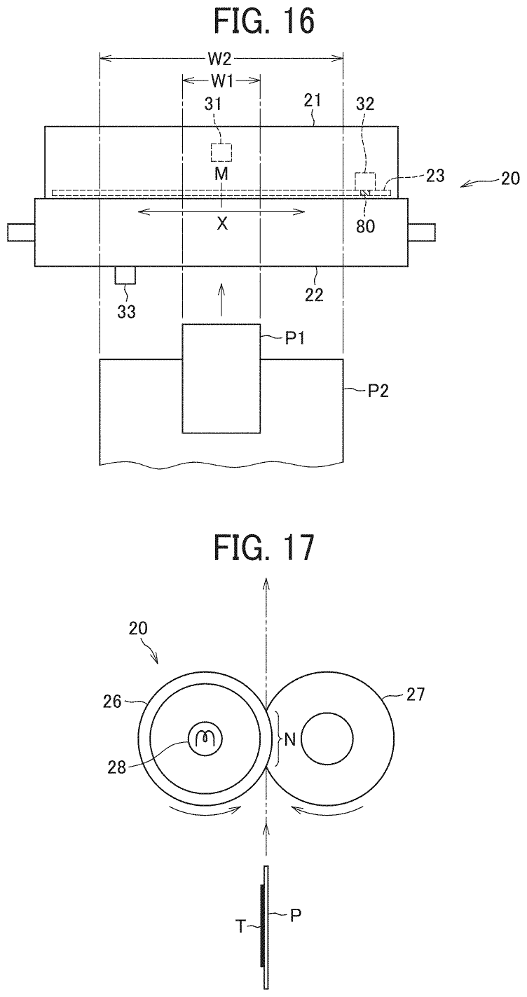

With reference to FIG. 16, a fourth embodiment of present disclosure is described.

The fixing device 20 according to the fourth embodiment as illustrated in FIG. 16 includes a positioner 80 to position the heater 23 in the longitudinal direction of the heater 23 (that is, the direction indicated by arrow X in FIG. 16) with respect to the heater holder 24. The positioner 80 is configured by, for example, a recess formed in the heater 23 and a projection formed in the heater holder 24, the projection that can be engaged to the recess.

As illustrated in FIG. 16, the positioner 80 disposed at a position from the center M of the heater 23 in the longitudinal direction to one end of the heater 23 surely positions the heater 23 in the longitudinal direction of the heater 23 with respect to the heater holder 24 at the position at which the positioner 80 is disposed. In contrast, the heater 23 and the heater holder 24 do not have the positioner 80 at a position on the other end of the heater 23. As a result, the thermal expansion of the heater 23 caused by the temperature increase changes positions on the other end of the heater 23 in the longitudinal direction of the heater 23. Accordingly, the thermal expansion of the heater 23 causes a positional deviation between the heater 23 and the temperature sensor disposed near the other end of the heater 23 in which the above-described positional change is likely to occur and causes a variation in the temperatures detected by the temperature sensor. The closer the temperature sensor is from the center of the heater 23 to the other end, the larger the variation in the temperatures detected by the temperature sensor that is the variation caused by the positional change of the heater 23 in the longitudinal direction with respect to the temperature sensor.

For this reason, the heater temperature sensor 32 is preferably disposed closer to the positioner 80 than the center M of the heater 23 in the longitudinal direction as in the fourth embodiment. The above-described configuration prevents the heater temperature sensor 32 from being affected by relative positional deviation due to the thermal expansion of the heater 23 and prevents deterioration in detection accuracy of the heater temperature sensor 32.

Although embodiments of the present disclosure are described above, the present disclosure is not limited to those embodiments and can be applied to other embodiments by modification of the fixing device. As illustrated in FIG. 17, the fixing device 20 may include a fixing roller 26 as the fixing rotator, a halogen heater 28 as the heater, and a pressure roller 27 as the pressure rotator.

The embodiments of the present disclosure is not limited to the fixing device incorporated in the image forming apparatus using a so-called center conveyance reference system as illustrated in FIG. 7 in which the sheets having various sizes are conveyed so that the center positions M of the various sizes of sheets in the width direction pass through a same position in the image forming apparatus. The fixing device according to the present disclosure may also be applied to an image forming apparatus using a so-called end conveyance reference system in which the sheets having various sizes are conveyed so that one ends of the sheets in the width direction thereof pass through a same position in the image forming apparatus.

A heating device according to the embodiments of the present disclosure is not limited to the fixing device that is an example of the heating device. For example, the embodiments of the present disclosure may be applied to a dryer in an inkjet type image forming apparatus. The dryer is the heating device that heats the sheet to dry liquid such as ink discharged to the sheet.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. A heating device comprising:
a first rotator;
a second rotator being in contact with an outer circumferential surface of the first rotator to form a nip to allow a recording medium to pass through;
a heater configured to heat the first rotator;
a first temperature sensor disposed outside a space extending from a first region to allow a minimum recording medium to pass through, the first temperature sensor configured to detect a temperature of the first rotator;
a second temperature sensor disposed outside the space extending from the first region, the second temperature sensor configured to detect a temperature of the heater; and
a third temperature sensor disposed outside the space extending from the first region, the third temperature sensor configured to detect a temperature of the second rotator,
wherein at least one of the second temperature sensor or the third temperature sensor is disposed outside a space extending from a second region to allow a maximum recording medium to pass through.

2. The heating device according to claim 1,
wherein the second temperature sensor is disposed outside the space extending from the second region, and
wherein the third temperature sensor is disposed outside the space extending from the first region and inside the space extending from the second region.

3. The heating device according to claim 1,
wherein the second temperature sensor is disposed outside the space extending from the first region and inside the space extending from the second region, and
wherein the third temperature sensor is disposed outside the space extending from the second region.

4. The heating device according to claim 1,
wherein the first region is between the second temperature sensor and the third temperature sensor in a width direction of the recording medium.

5. The heating device according to claim 1,
wherein the first temperature sensor is disposed inside a loop of the first rotator.

6. The heating device according to claim 1,
wherein the first rotator is an endless fixing belt, wherein the heater is disposed inside a loop of the first rotator, and
wherein the second rotator is a pressure rotator pressed against the heater via the endless fixing belt.

7. An image forming apparatus comprising
the heating device according to claim 1.
